(19) United States
(12) Patent Application Publication
(10) Pub. No.: US 2012/0102700 A1
(43) Pub. Date: May 3, 2012

(54) CUTTING AND CLAMPING DEVICE

(75) Inventors: TSUNG-HAN WEI, Tu Cheng (TW); Feng-chi Lee, Tu Cheng (TW); Kuo-chuan Chiu, Tu Cheng (TW)

(73) Assignee: Cheng Uei Precision Industry Co., LTD., Tu Cheng City (TW)

(21) Appl. No.: 12/916,583

(22) Filed: Oct. 31, 2010

(51) Int. Cl. B23P 23/00

(52) U.S. Cl. 29/33 K

(57) ABSTRACT

A cutting and clamping device includes an electrical control box. A base board is mounted atop the electrical control box and includes slide rails and a slide block. A supply mechanism is mounted to the base board for supplying an un-processed part strip. A conveyance mechanism is mounted to the slide block and has one end adjacent to the supply mechanism. A forwarding mechanism is mounted on the conveyance mechanism and includes a sharp tip, which is releasably insertable into positioning holes defined in the part strip. A cutting mechanism is mounted to the slide block and is connected to an opposite end of the conveyance mechanism. The cutting mechanism includes a cutting blade assembly and defines a cutting zone into which the cutting blade assembly is extendable. A clamping and retaining mechanism includes a first clamp assembly, a second clamp assembly, and a retaining assembly.

### BACKGROUND OF THE INVENTION

1. Field of the Invention

The present invention generally relates to a cutting and clamping device, and in particular to a cutting and clamping device that cuts off and clamps work pieces carried by a part strip.

2. The Related Arts

With the progress of science and technology, living standards of human beings everywhere around the world have been greatly improved. Electronic products are now a must of regular living of modern people. Nowadays, the electronic products are evolving in a new trend of miniaturization and function diversification.

An electronic component that serves as transmission of electronic signal for and mechanical coupling of an electronic device will often leads to failure of the electronic device, if the electronic component is not functioning properly. Thus, the manufacturing and assembling of the electronic component is subjected to server requirement for each step or process. Currently, in the manufacturing process of electronic components, parts of the electronic components are often provided in such a form as being attached to a part strip. Before these parts are soldered or welded to a semi-finished electronic product, jigs are used to cut the parts off the part strip so as to separate the parts from the part strip. And then, the parts are conveyed to other devices where the parts are neatly arranged for subsequently positioning into a holder through manual operations, after which soldering may be carried out for the semi-finished electronic product. Since the operation of positioning the parts into the holder is carried out manually, certain problems are easily caused, such as oxidization and deformation of the parts, which lead to uncontrollable inconsistency of quality and increased flaw rate. Further, moving the parts to other devices for neat arrangement and then manually positioning the parts to a holder are apparently complicated, and cause undesired increase of loading of the operators, eventually leading to poor manufacturing efficiency, increased cost, and incapability of meeting the need for mass production.

Thus, it is desired to provide a cutting and clamping device that overcomes the above discussed problems.

### SUMMARY OF THE INVENTION

In order to overcome the problems discussed above, an objective of the present invention is to provide a cutting and clamping device, which improves manufacturing efficiency, reduces flaw rate and manufacturing costs, alleviates the loading of operators, and helps realizing mass production.

To achieve the above objective, according to the present invention, a cutting and clamping device is provided, comprising an electrical control box, a base board, a supply mechanism, a conveyance mechanism, a forwarding mechanism, a cutting mechanism, and a clamping and retaining mechanism. The base board is mounted on a top of the electrical control box and comprises slide rails fixed thereto. The slide rails are slidably coupled to a slide block. The supply mechanism is mounted to the base board for loading and supplying an un-processed part strip. The conveyance mechanism is mounted to the slide block and has one end set adjacent to the supply mechanism. The conveyance mechanism defines a part transportation zone for transporting the part strip. The forwarding mechanism is mounted on the conveyance mechanism and comprises a sharp tip. The sharp tip is releasably insertable into positioning holes defined in the part strip located in the part transportation zone. The cutting mechanism is mounted to the slide block and is connected to an opposite end of the conveyance mechanism. The cutting mechanism comprises a cutting blade assembly and defines a cutting zone that is in communication with the part transportation zone for transporting the part strip. The cutting blade assembly is extendable into the cutting zone. The clamping and retaining mechanism comprises a first clamp assembly, a second clamp assembly, and a retaining assembly. The first clamp assembly comprises a fixed board, a first slide member, and a first jaw set. The fixed board is fixed to the slide block and has an end located adjacent to the cutting mechanism. The slide member is slidably coupled to the fixed board. The first jaw set is mounted to the slide member to oppose the cutting zone of the cutting mechanism. The second clamp assembly comprises mounting racks, a horizontal displacement cylinder, a cross beam, a second slide assembly, and a second jaw set. The mounting racks have lower ends mounted to the base board. The cross beam has an end portion mounted to upper ends of the mounting racks and extends above the first clamp assembly. The second slide assembly is coupled to the cross beam in a horizontally slidable manner. The second jaw set is mounted to the second slide assembly. The retaining assembly is fixed to a side surface of the base board to be set at a location under an opposite end portion of the cross beam. The retaining assembly is provided for holding a jig thereon, whereby when the second slide assembly is selectively driven by the horizontal displacement cylinder to slide to said opposite end portion of the cross beam, the second jaw set that is mounted to the second slide assembly is located above the jig.

In summary, the cutting and clamping device according to the present invention is capable of automatically cutting off a part carried by a part strip and automatically moving the metal plate to a jig immediately after the cutting. This eliminate the complicated procedure that is currently employed for manual operation, whereby the operation efficiency is significantly improved, product flaw rate and manufacturing cost are reduced, and working load of operators is alleviated. Further, the operation of the cutting and clamping device according to the present invention is stable and product quality is reliable, and thus, the needs for mass production can be met.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view showing a cutting and clamping device according to the present invention;

FIG. 2 is another perspective view of the cutting and clamping device shown in FIG. 1;

FIG. 3 is a schematic view of a part strip to be processed by the cutting and clamping device shown in FIG. 1;

FIG. 4 is a perspective view of a portion of the cutting and clamping device shown in FIG. 1;

FIG. 5 is a perspective view of a conveyance mechanism and a forwarding mechanism of the cutting and clamping device shown in FIG. 1;

FIG. 6 is an exploded view of the conveyance mechanism and the forwarding mechanism of the cutting and clamping device shown in FIG. 5;

FIG. 7 is a perspective view of a portion of the cutting and clamping device shown in FIG. 1;

FIG. 8 is a perspective view of a cutting mechanism of the cutting and clamping device shown in FIG. 1;

FIG. 9 is an exploded view of the cutting mechanism of the cutting and clamping device shown in FIG. 8;

FIG. 10 is a perspective view of a first clamp assembly of the cutting and clamping device shown in FIG. 1;

FIG. 11 is a perspective view of a second clamp assembly of the cutting and clamping device shown in FIG. 1;

FIG. 12 is a perspective view of a retaining assembly of the cutting and clamping device shown in FIG. 1; and

FIG. 13 is an exploded view of a reversal prevention mechanism of the cutting and clamping device shown in FIG. 1.

### DETAILED DESCRIPTION OF PREFERRED EMBODIMENT

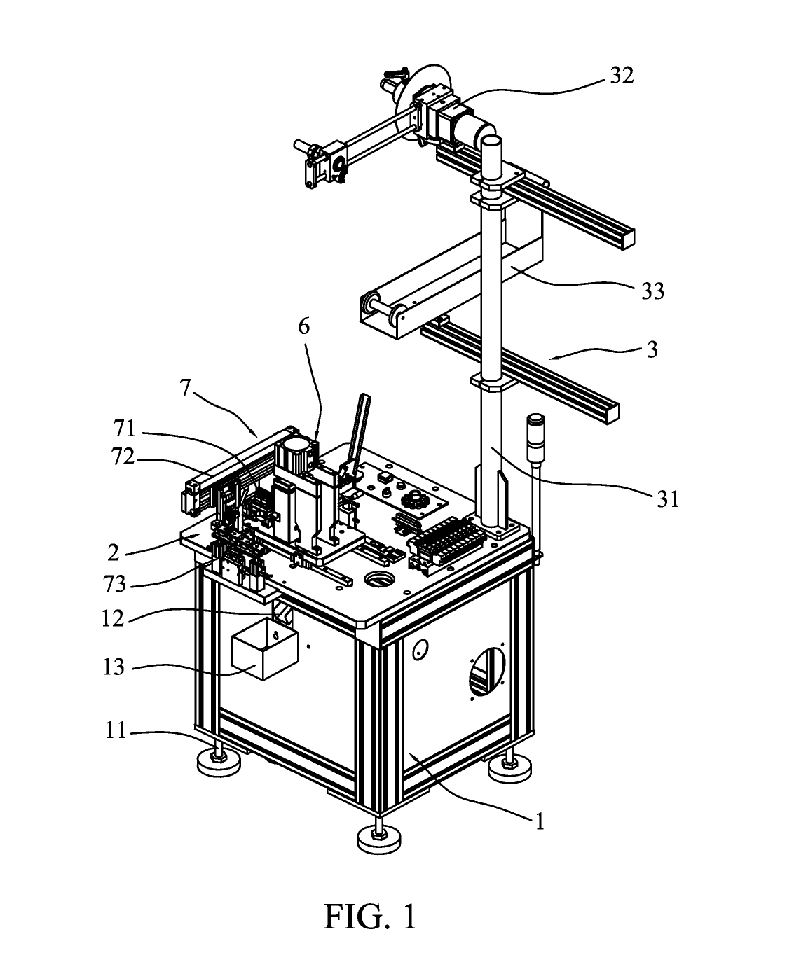

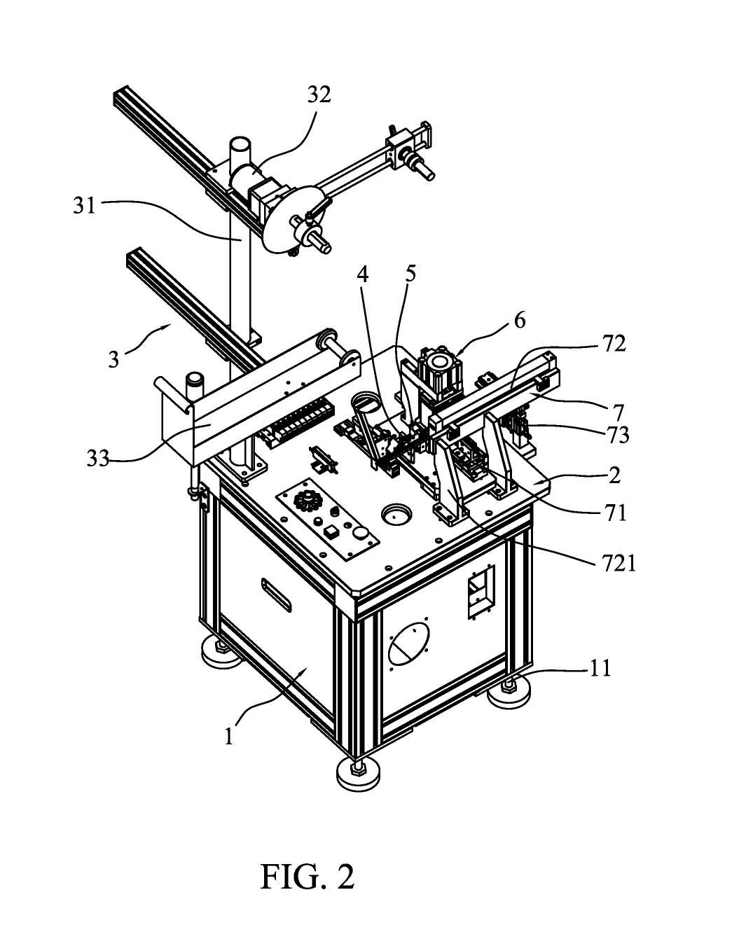

With reference to the drawings and in particular to FIGS. 1 and 2, a cutting and clamping device constructed in accordance with the present invention comprises an electrical control box 1, a base board 2, a supply mechanism 3, a conveyance mechanism 4, a forwarding mechanism 5, a cutting mechanism 6, and a clamping and retaining mechanism 7.

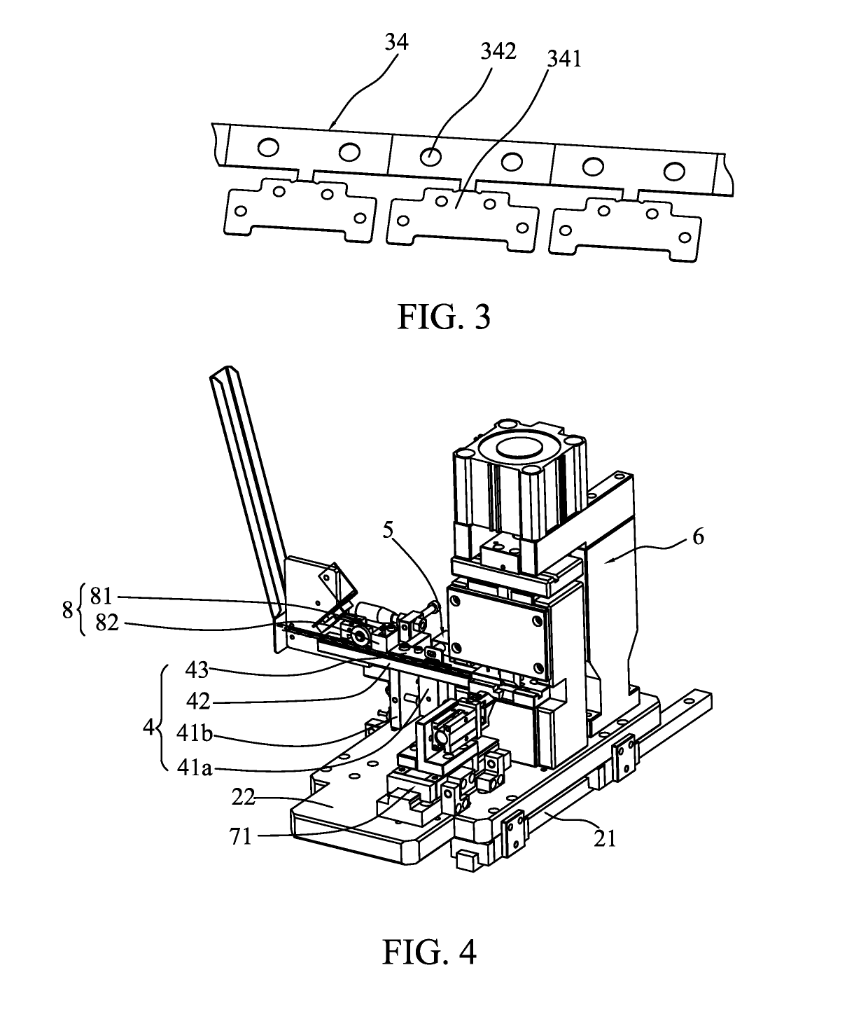

Reference is now made to FIGS. 1-4, the electrical control box 1 is of an elongate parallelepiped configuration. The base board 2 is mounted to a top of the electrical control box 1 and comprises slide rails 21 fixedly mounted thereon. The slides rails 21 support and are slidably coupled to a slide block 22. The electrical control box 1 has an underside to which legs 11 are mounted for supporting the electrical control box 1. The supply mechanism 3 comprises a support frame 31, a supply tray (not shown), a supply tray driving device 32, and a guide member 33. The support frame 31 has a lower end fixed to the base board 2. The supply tray and the supply tray driving device 32 are mounted to an upper end of the support frame 31. The supply tray receives and contains therein a part strip 34 to be cut. The guide member 33 is fixed to the support frame 31 under and close to the supply tray, whereby the guide member 33 guides the part strip 34 in a direction toward the conveyance mechanism 4 and prevent the part strip 34 from falling to the base board 2. Specifically, according to the present invention, the part strip 34 is connected to metal plates 341, and the part strip 34 defines positioning holes 342. The part strip 34 can be constructed to connect to and carry different electronic components/parts, such as conductive terminals.

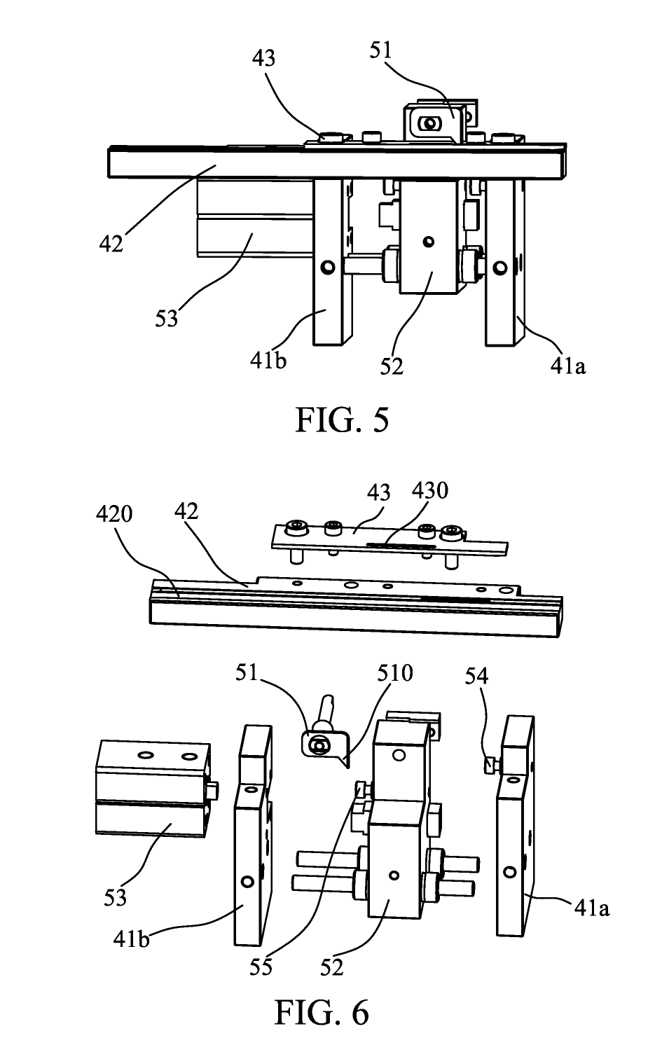

Referring to FIGS. 1 and 4-6, the conveyance mechanism 4 is mounted on the slide block 22 in such a way that one end of the conveyance mechanism 4 is set adjacent to the supply mechanism 3. Specifically, the conveyance mechanism 4 comprises spacer boards 41, a support board 42, and a retention board 43. The spacer boards 41 include a first spacer board 41a and a second spacer board 41b. The first spacer board 41a has a lower end mounted to the slide block 22 and the first spacer board 41a is located immediately adjacent to the cutting mechanism 6. The second spacer board 41b has a lower end mounted to the slide block 22 and the second spacer board 41b is spaced from the first spacer board 41a by a distance. Upper ends of the first spacer board 41a and the second spacer board 41b are located on the same horizontal plane. The support board 42 is mounted on the upper ends of the first spacer board 41a and the second spacer board 41b. The support board 42 has a top surface forming a recess 420, which constitutes a part transportation zone for the part strip 34. The support board 42 supports the retention board 43 fixed thereon. The retention board 43 functions to confine the part strip 34 within the part transportation zone. The retention board 43 forms a slot 430 corresponding to the part transportation zone.

The forwarding mechanism 5 comprises a driver block 51, a connection member 52, and a forwarding cylinder 53. The connection member 52 has a lower end slidably arranged between the first spacer board 41a and the second spacer board 41b. The driver block 51 is rotatably mounted to an upper end of the connection member 52. The driver block 51 has a lower end forming a sloped configuration, which defines a sharp tip 510. The sharp tip 510 is extendable through the slot 430 and releasably engageable with the positioning holes 342 of the part strip 34 located in the part transportation zone. The forwarding cylinder 53 is coupled to the connection member 52 for selectively driving the connection member 52 to slide or move between the first spacer board 41a and the second spacer board 41b. Since the lower end of the driver block 51 is of a sloped configuration, the driver block 51 is only capable of moving or driving the part strip 34 in a forward direction. When the driver block 51 moves backwards, the sloped configuration is incapable of moving the part strip 34 in a backward direction.

Specifically, the forwarding mechanism 5 comprises a first stop bolt 54 that is mounted to the first spacer board 41a and a second stop bolt 55 that is mounted to the connection member 52. The second stop bolt 55 has a free end releasably engageable with the second spacer board 41b, whereby when the second stop bolt 55 is in engagement with the second spacer board 41b, the distance between the first stop bolt 54 and the connection member 52 is the distance along which the connection member 52 is allowed to move, which substantially corresponds to the spacing between two adjacent positioning holes 342 defined in the part strip 34. Consequently, for part strips of different sizes, the first stop bolt 54 or the second stop bolt 55 may be loosened or tightened to define an interval corresponding to the distance between two adjacent positioning holes 342 of any specific part strip 34.

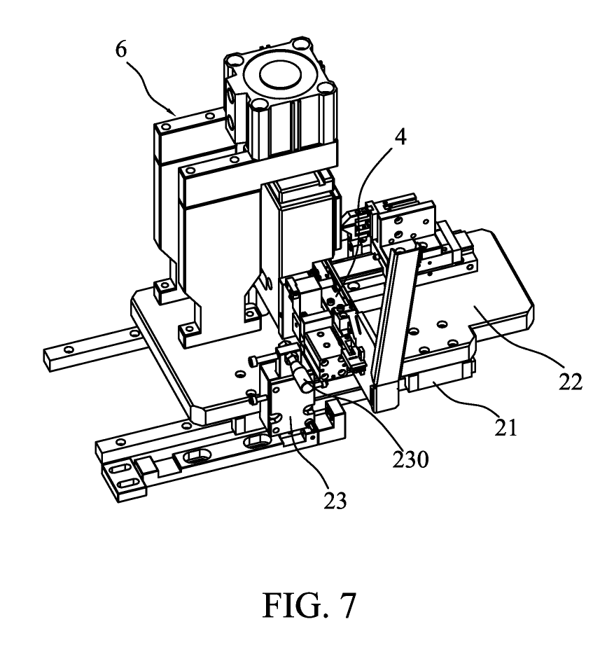

Referring to FIG. 7, the cutting mechanism 6 is mounted on the slide block 22 and is connected to an opposite end of the conveyance mechanism 4. In the instant embodiment, the slide block 22 has a side forming a recess (not shown). The base board 2 comprises a retainer block 23, which functions to constrain the sliding movement of the slide block 22. The retainer block 23 is removably received and retained in the recess. The retainer block 23 comprises a pull bar 230 mounted thereon, whereby when an attempt is made to replace or maintain the cutting mechanism 6, the pull bar 230 is first pulled to allow the retainer block 23 to be removed out of the recess, and this allows the slide block 22 and the cutting mechanism 6 that is mounted on the slide block 22 to slide backward along the slide rails 21 for facilitating operations to be carried thereon.

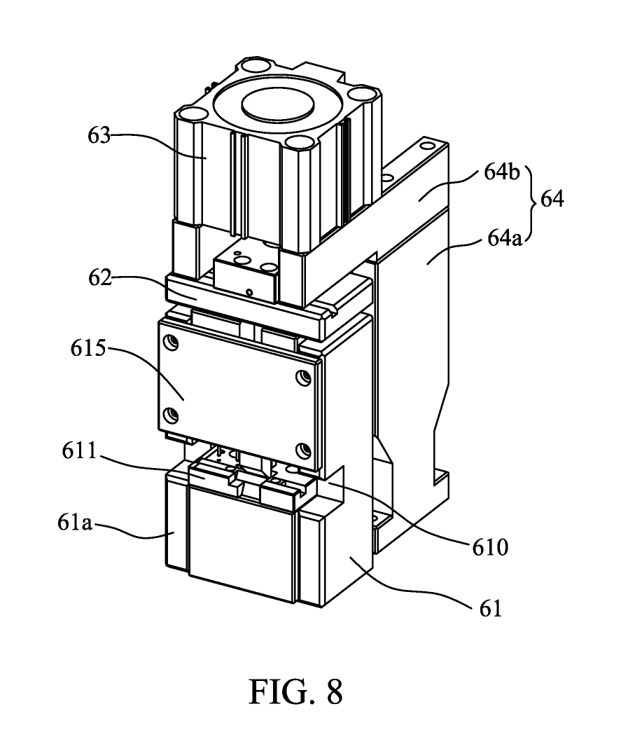

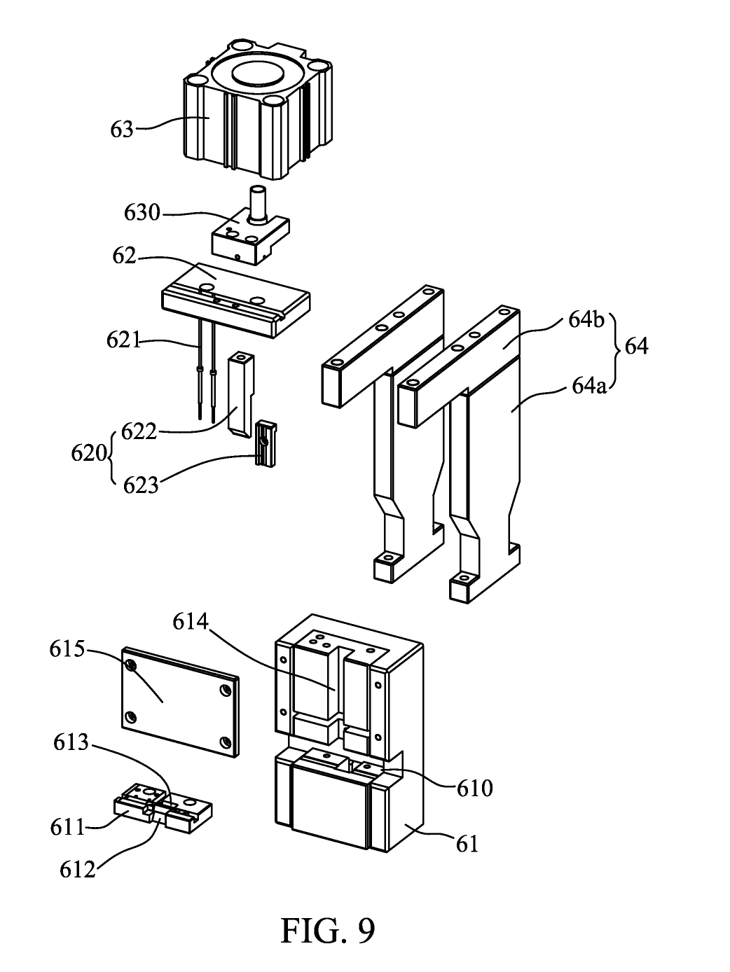

Referring to FIGS. 8 and 9, the cutting mechanism 6 comprises a die support board 61, a punch cutter board 62, and an operation cylinder 63. The die support board 61 has a side surface 61a opposing the clamping and retaining mechanism 7. The side surface 61a forms a first channel 610 that extends in a horizontal direction. The first channel 610 receives and retains therein a cutter spacer board 61, in which a first cutting opening 612 and a second cutting opening 613 are formed. The cutter spacer board 611 has a top surface defining a cutting zone and the cutting zone is in communication with the part transportation zone for supporting a part strip 34 thereon for the performance of a cutting operation. The side surface 61a of the die support board 61 forms a second channel 614 extending in a vertical direction. The second channel 614 is in communication with the first channel 610. The punch cutter board 62 comprises a cutting blade assembly 620 and fixing pins 621 mounted thereto. The fixing pins 621 respectively extend through the positioning holes 342 of a part strip 34 to securely hold the part strip 34 at a location above the first cutting opening 612 and the second cutting opening 613. The cutting blade assembly 620 comprises a first cutting blade 622 and a second cutting blade 623. The first and second cutting blades 622, 623 are received in the second channel 614 and are extendible into the first channel 610. The first cutting blade 622 is located exactly above the first cutting opening 612 and functions to cut a metal plate 341 off a part strip 34. The second cutting blade 623 is located above the second cutting opening 613 to cut off the portion of the part strip 34 of which the metal plate 341 has been cut off. The side surface 61a of the die support board 61 also comprises a cover plate 615 attached thereto. The cover plate 615 functions to shield and maintain the first cutting blade 622 and the second cutting blade 623 within the second channel 614. In the present invention, the punch cutter board 62 can be replaced according to specific work pieces to be processed by the device.

Specifically, the cutting mechanism 6 comprises racks 64, which are each of an L-shape, comprising a vertical section 64a and a horizontal section 64b. The vertical section 64a has a lower end mounted to the slide block 22. The horizontal section 64b is connected, in a substantially perpendicular manner, to an upper end of the vertical section 64a and extends above the punch cutter board 62. The operation cylinder 63 is mounted to the horizontal section 64b and comprises a transmission shaft 630. The transmission shaft 630 has an end slidably coupled to the operation cylinder 63 and an opposite end connected to the punch cutter board 62. The operation cylinder 63 drives the punch cutter board 62 to do vertical reciprocal movement, and thus the first cutting blade 622 and the second cutting blade 623 mounted to the punch cutter board 62 are caused to respectively carry out cutting operations on a metal plate 341 of a part strip 34 and the portion of the part strip 34 of which the metal plate has been cut off.

Referring to FIGS. 1 and 9, the die support board 61, the slide block 22, the base board 2, and the top of the electrical control box 1 respectively form aligned openings (not shown) corresponding to the second cutting opening 613. The electrical control box 1 comprises therein a chute (not shown). The chute is connected to the opening formed in the top of the electrical control box to allow the portions of the part strip 34 that are separated from the strip 34 to pass through these openings. The chute has a discharge opening 12 formed in a side wall of the electrical control box 1 and a collection bin 13 is set below the discharge opening 12 to receive and collect the portions of the part strip 34 that are separated from the strip 34 and of which the metal plates 341 have been removed.

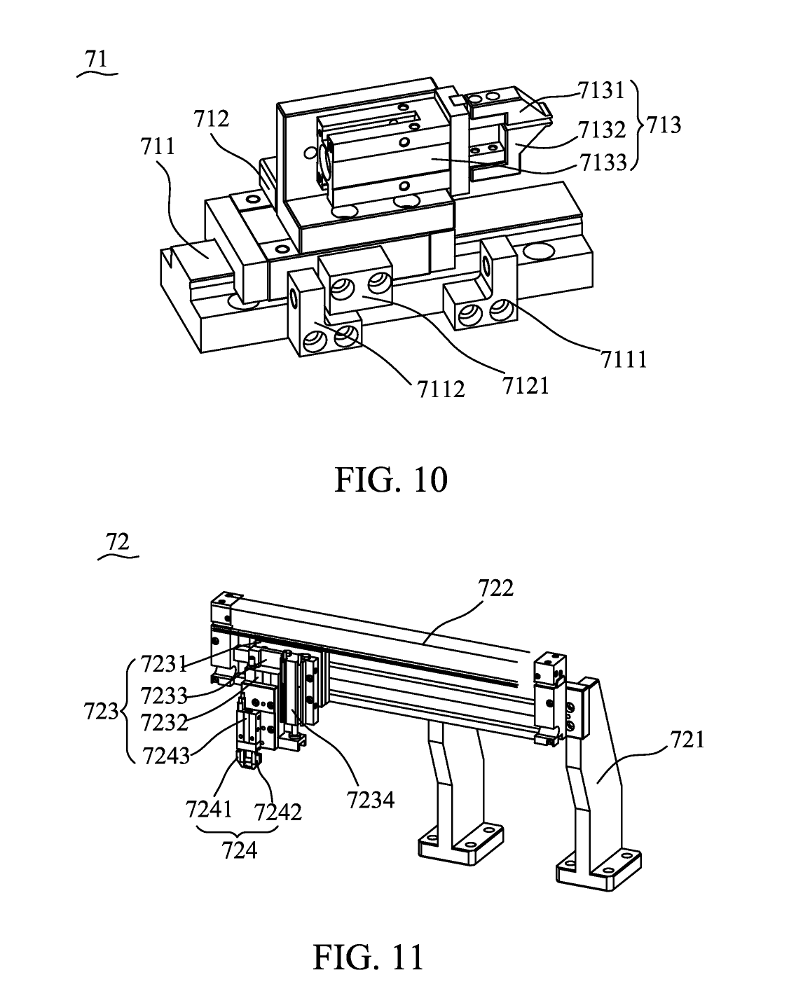

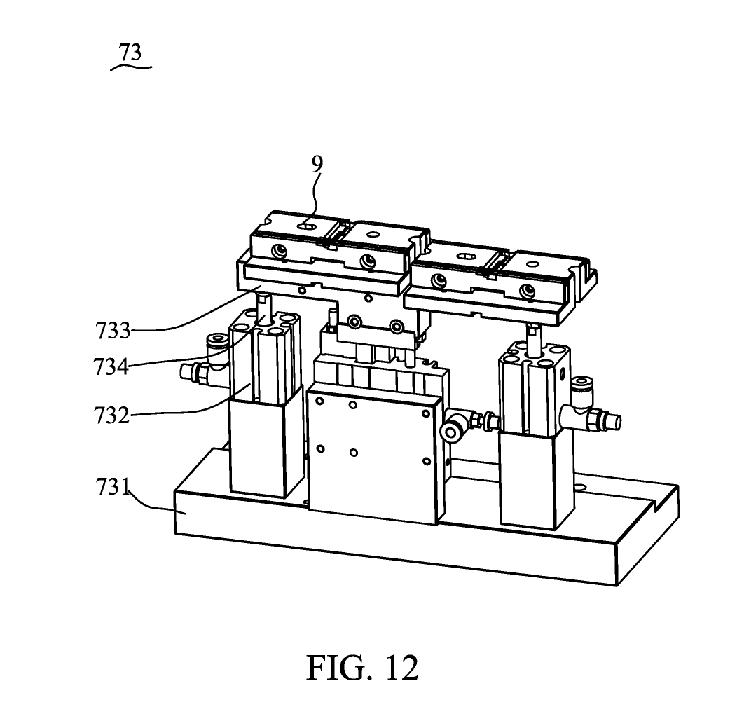

Referring to FIGS. 1, 4, and 10-12, the clamping and retaining mechanism 7 comprises a first clamp assembly 71, a second clamp assembly 72, and a retaining assembly 73. The first clamp assembly 71 comprises a fixed board 711, a first slide member 712, and a first jaw set 713. The fixed board 711 is mounted on the slide block 22 and has an end located adjacent to a lower portion of the side surface 61a. The first slide member 712 is slidably coupled to the fixed board 711. A first stop block 7111 is mounted to an end of the fixed board 711 and a second stop block 7112 is mounted to an opposite end of the fixed board 711. The first slide member 712 comprises a projection block 7121 mounted thereon. The projection block 7121 is arranged between the first stop block 7111 and the second stop block 7112. The first jaw set 713 is mounted on the first slide member 712 and comprises an upper jaw 7131, a lower jaw 7132, and a first jaw set cylinder 7133. The upper and lower jaws 7131, 7132 define a first pinching opening therebetween. The first pinching opening is set exactly opposing the cutting zone, whereby when the projection block 7121 slides to one end of the fixed board 711 and engages the first stop block 7111, the first pinching opening reaches into the cutting zone and then the first jaw set cylinder 7133 drives the upper and lower jaws 7131, 7132 that define the first pinching opening to approach each other thereby securely pinch the metal plate 341 of the part strip 34 located in the cutting zone; and when the projection block 7121 slides to an opposite ends of the fixed board 711 and engages the second stop block 7112, the first jaw set 713 is located below the second clamp assembly 72.

The second clamp assembly 72 comprises mounting racks 721, a horizontal displacement cylinder (not shown), a cross beam 722, a second slide assembly 723, and a second jaw set 724. The mounting racks 721 have lower ends mounted to the base board 2. The cross beam 722 has an end portion mounted to upper ends of the mounting racks 721 and extend above and across the first clamp assembly 71. The second slide assembly 723 comprises a first slide plate 7231, a second slide plate 7232, a connection plate 7233, and a vertical cylinder 7234. The first slide plate 7231 is slidably coupled to the cross beam 722. The connection plate 7233 is fixed to the first slide plate 7231 and forms a guide channel (not shown). The second slide plate 7232 comprises a guide axle (not shown) mating the guide channel. An end of the second slide plate 7232 is coupled to the vertical cylinder 7234, whereby the vertical cylinder 7234 drives the second slide plate 7232 to cause the guide axle to reciprocally and vertically move along the guide channel of the connection plate 7233. The second jaw set 724 is mounted to the second slide plate 7232 and comprises a second jaw set cylinder 7243 coupled thereto. The second jaw set 724 comprises a left jaw 7241 and a right jaw 7242. The left and right jaws 7241, 7242 define therebetween a second pinching opening. The second jaw set cylinder 7243 drives the left and right jaws 7241, 7242 that define the second pinching opening to approach or separate from each other thereby clamping or releasing a metal plate.

The retaining assembly 73 comprises a mounting board 731, an adjustment cylinder 732, and a carriage block 733. The mounting board 731 is fixed to one side surface of the base board 2 to be set at a location under an opposite end portion of the cross beam 722. The adjustment cylinder 732 is mounted on the mounting board 731 and comprises an adjustment shaft 734, which has an end coupled to the adjustment cylinder 732 and an opposite end coupled to the carriage block 733. The carriage block 733 functions to hold a jig 9 thereon. The adjustment cylinder 732 drives reciprocal movement of the adjustment shaft 734 in a vertical directly to cause the carriage block 733 and the jig 9 held on the carriage block 733 to reciprocally and vertically move. When the second slide assembly 723 is driven by the horizontal displacement cylinder to reach said opposite end of the cross beam 722, the second jaw set 724 that is mounted to the second slide assembly 723 is located above the jig 9.

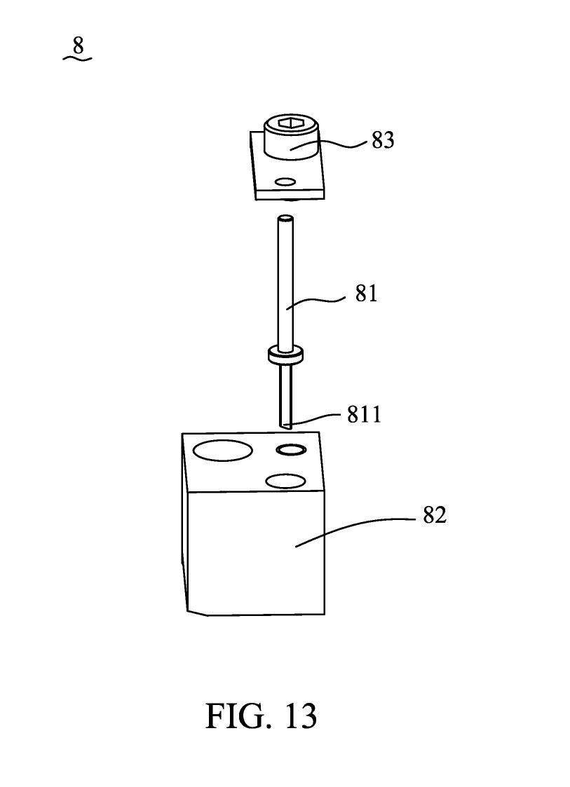

Referring to FIGS. 4 and 13, the cutting and clamping device according to the present invention further comprises a reversal prevention mechanism 8, which comprises a reversal prevention pin 81 and a holder block 82. The holder block 82 is mounted on the support board 42 and located adjacent to the retention board 43. The holder block 82 confines a part strip 34 to move within the part transportation zone. The reversal prevention pin 81 is rotatably mounted by a mounting bolt 83 to the holder block 82. The reversal prevention pin 81 has a lower end forming a slope structure 811. The slope structure 811 is removably insertable into one of the positioning holes 342 of the part strip 34 located in the part transportation zone. As being operated in the same way as the sloped configuration of the driver block 51, the slope structure 811 of the reversal prevention pin 81 helps preventing the part strip 34 from moving backward.

Referring to FIGS. 1-13, the cutting and clamping device according to the present invention is operated as follows. To cut a metal plate 341 off a part strip 34, an un-processed part strip 34 received in the supply tray is first moved to the part transportation zone of the conveyance mechanism 4, meanwhile the sharp tip 510 of the driver block 51 of the forwarding mechanism 5 is put into one of the positioning holes 342 defined in the part strip 34. Under this condition, the forwarding cylinder 53 of the forwarding mechanism 5, after being signaled, starts to operate, so that the forwarding cylinder 53 drives the connection member 52 to slide in a direction toward the cutting mechanism 6, causing the part strip 34 to move forward to the cutting zone of the cutting mechanism 6. Then, the forwarding cylinder 53 drives the connection member 52 to move in a direction opposite to the forwarding direction to allow the sharp tip 510 of the driver block 51 to insert into the next one of positioning holes 342 of the part strip 34, so that when the connection member 52 is subsequently moved forward again toward the cutting mechanism 6, the part strip 34 is forwarded again to the cutting mechanism 6.

When the conveyance mechanism 4 conveys the part strip 34 to the cutting zone of the die support board 61, the operation cylinder 63 drives the punch cutter board 62 to move downward, during which the fixing pins 621 first extend through the positioning holes 342 of the part strip 34 to hold the part strip 34 at a location above the first cutting opening 612 and the second cutting opening 613 and then, the clamping and retaining mechanism 7, after being signaled, drives the first slide member 712 of the first clamp assembly 71 to slide to engage the first stop block 7111. At this moment, the first pinching opening of the first jaw set 713 extends into the cutting zone and the first jaw set cylinder 7133 drives the upper and lower jaws 7131, 7132 of the first pinching opening to approach each other so that the upper and lower jaw 7131, 7132 tightly clamp the metal plate 341 therebetween. Afterwards, the first cutting blade 622 of the punch cutter board 62 carries out a cutting operation on the metal plate 341 to separate the metal plate 341 from the part strip 34. Then, the second cutting blade 623 carries out a cutting operation on the portion of the part strip 34 from which the metal plate 341 has been separated to have the portion of the part strip 34 from which the metal plate 341 has been separated detached from the remaining portion of the part strip and moving through the second cutting opening 613 to reach the collection bin 13.

When the first pinching opening clamps the metal plate 341 and the metal plate 341 is separated from the part strip 34, the first slide member 712 slides to a location below the second clamp assembly 72. The second clamp assembly 72 is then signaled to drive the horizontal displacement cylinder and the vertical cylinder 7234 to operate to have the second pinching opening of the second jaw set 724 aligning the first pinching opening of the first jaw set 713. The first jaw set cylinder 7133 drives the upper and lower jaws 7131, 7132 of the first pinching opening to release the metal plate 34 and at the same time, the second jaw set cylinder 7243 drives the left and right jaws 7241, 7242 of the second pinching opening to tightly clamp the metal plate 341 released by the first pinching opening.

Subsequently, the horizontal displacement cylinder drives the second slide assembly 723 and the second jaw set 724 to slide to a location above the retaining assembly 73 to align the metal plate 341 with a receiving compartment defined in a jig 9 for receiving the metal plate 341. Under this condition, the left and right jaws 7241, 7242 of the second pinching opening separate from each other to position and retain the metal plate 341 in the jig 9. Finally, the jig 9 is transported to a spot welding device (not shown), where a semi-finish product (not shown) is loaded into the jig 9 to correspond to the metal plate 341 and then spot welding is carried out.

In summary, the cutting and clamping device according to the present invention is capable of automatically cutting a metal plate 341 from a part strip 34 and automatically moving the metal plate 341 to a jig 9 immediately after the cutting. This eliminate the complicated procedure that is currently employed for manual operation, whereby the operation efficiency is significantly improved, product flaw rate and manufacturing cost are reduced, and working load of operators is alleviated. Further, the operation of the cutting and clamping device according to the present invention is stable and product quality is reliable, and thus, the needs for mass production can be met.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A cutting and clamping device, comprising:
an electrical control box;
a base board, which is mounted on a top of the electrical control box and comprises slide rails fixed thereto, the slide rails being slidably coupled to a slide block;
a supply mechanism, which is mounted to the base board for supplying an un-processed part strip;
a conveyance mechanism, which is mounted to the slide block and has one end set adjacent to the supply mechanism, the conveyance mechanism defining a part transportation zone for transporting the part strip;
a forwarding mechanism, which is mounted on the conveyance mechanism and comprises a sharp tip, the sharp tip releasably insertable into positioning holes defined in the part strip located in the part transportation zone;
a cutting mechanism, which is mounted to the slide block and is connected to an opposite end of the conveyance mechanism, the cutting mechanism comprising a cutting blade assembly and defining a cutting zone that is in communication with the part transportation zone for transporting the part strip, the cutting blade assembly being extendable into the cutting zone; and
a clamping and retaining mechanism, which comprises a first clamp assembly, a second clamp assembly, and a retaining assembly, the first clamp assembly comprising a fixed board, a first slide member, and a first jaw set, the fixed board being fixed to the slide block and having an end located adjacent to the cutting mechanism, the first slide member being slidably coupled to the fixed board, the first jaw set being mounted to the first slide member to oppose the cutting zone of the cutting mechanism, the second clamp assembly comprising mounting racks, a horizontal displacement cylinder, a cross beam, a second slide assembly, and a second jaw set, the mounting racks having lower ends mounted to the base board, the cross beam having an end portion mounted to upper ends of the mounting racks and extending above the first clamp assembly, the second slide assembly being coupled to the cross beam in a horizontally slidable manner, the second jaw set being mounted to the second slide assembly, the retaining assembly being fixed to a side surface of the base board to be set at a location under an opposite end portion of the cross beam, the retaining assembly being adapted to hold a jig thereon, whereby when the second slide assembly is selectively driven by the horizontal displacement cylinder to slide to said opposite end portion of the cross beam, the second jaw set that is mounted to the second slide assembly is located above the jig.

2. The cutting and clamping device as claimed in claim 1, wherein the fixed board has an end to which a first stop block is mounted and an opposite end to which a second stop block is mounted, the first slide member forming a projection block, which is located between the first stop block and the second stop block, the first jaw set comprising an upper jaw, a lower jaw, and a first jaw set cylinder, the upper and lower jaws defining a first pinching opening therebetween, whereby when the projection block slides to one end of the fixed board and engages the first stop block, the first pinching opening reaches into the cutting zone and the first jaw set cylinder drives the upper and lower jaws that define the first pinching opening to tightly clamp a work piece attached to the part strip located in the cutting zone and when the projection block slides to an opposite end of the fixed board and engages the second stop block, the first pinching opening releases the work piece with the work piece being clamped by the second clamp assembly.

3. The cutting and clamping device as claimed in claim 1, wherein the second slide assembly comprises a first slide plate, a second slide plate, a connection plate, and a vertical cylinder, the first slide plate being slidably coupled to the cross beam, the connection plate being fixed to the first slide board, the connection plate forming a guide channel, the second slide plate comprising a guide axle mating the guide channel, the second slide plate having an end coupled to the vertical cylinder, whereby the vertical cylinder drives the second slide plate to causes the guide axle to reciprocally and vertically move along the guide channel of the connection plate, the second jaw set being mounted to the second slide plate and comprising a second jaw set cylinder, the second jaw set comprising a left jaw and a right jaw, the left and right jaws defining therebetween a second pinching opening, the second jaw set cylinder driving the left and right jaws that define the second pinching opening to selectively clamp/release a work piece.

4. The cutting and clamping device as claimed in claim 1, wherein the conveyance mechanism comprises spacer boards, a support board, and a retention board, the spacer boards comprising a first spacer board and a second spacer board, the first spacer board having a lower end mounted to the slide block, the first spacer board being located immediately adjacent to the cutting mechanism, the second spacer board having a lower end mounted to the slide block, the second spacer board being spaced from the first spacer board by a distance, the first spacer board and the second spacer board having upper ends located on a common horizontal plane, the support board being mounted on the upper ends of the first spacer board and the second spacer board, the support board having a top surface forming a recess, which constitutes the part transportation zone for the part strip, the support board supporting the retention board fixed thereon, the retention board confining the part strip within the part transportation zone, the retention board forming a slot corresponding to the part transportation zone.

5. The cutting and clamping device as claimed in claim 4, wherein the forwarding mechanism comprises a driver block, a connection member, and a forwarding cylinder, the connection member having a lower end slidably arranged between the first spacer board and the second spacer board, the driver block being rotatably mounted to an upper end of the connection member, the driver block having a lower end forming a sloped configuration, which defines the sharp tip, the sharp tip being extendible through the slot and releasably engageable with the positioning holes of the part strip located in the part transportation zone, the forwarding cylinder selectively driving the connection member to slide between the first spacer board and the second spacer board.

6. The cutting and clamping device as claimed in claim 5, wherein the forwarding mechanism comprises a first stop bolt mounted to the first spacer board and a second stop bolt mounted to the connection member, the second stop bolt having an end releasably engageable with the second spacer board, whereby when the second stop bolt is in engagement with the second spacer board, the first stop bolt defines a distance with respect to the connection member, the connection member being movable within said distance, any two adjacent positioning holes defined in the part strip being spaced by an interval corresponding to said distance.

7. The cutting and clamping device as claimed in claim 1, wherein the cutting mechanism comprises a die support board, a punch cutter board, and an operation cylinder, the die support board having a side surface opposing the clamping and retaining mechanism, the side surface forming a first channel extending in a horizontal direction, the first channel forming the cutting zone, the cutting zone comprising cutting openings, the side surface of the die support board that opposes the clamping and retaining mechanism forming a second channel extending in a vertical direction, the second channel being in communication with the first channel, the punch cutter board comprising the cutting blade assembly mounted thereto, the cutting blade assembly being received in the second channel and extendible into the first channel, the cutting blade assembly being located exactly above the cutting openings, the operation cylinder driving the punch cutter board to reciprocally move in a vertical direction so that the cutting blade assembly mounted to the punch cutter board is caused to carry out cutting operation on a work piece attached to the part strip located in the cutting zone.

8. The cutting and clamping device as claimed in claim 7, wherein the cutting mechanism comprises racks, which are of an L-shape, comprising a vertical section and a horizontal section, the vertical section having a lower end mounted to the base board, the horizontal section being connected in a substantially perpendicular manner to an upper end of the vertical section and extending above the punch cutter board, the operation cylinder being mounted to the horizontal section and comprising a transmission shaft, the transmission shaft having an end coupled to the operation cylinder and an opposite end connected to the punch cutter board.

9. The cutting and clamping device as claimed in claim 4 further comprising a reversal prevention mechanism, which comprises a reversal prevention pin and a holder block, the holder block being mounted on the support board and located adjacent to the retention board, the holder block confining the part strip to move within the part transportation zone, the reversal prevention pin being rotatably mounted to the holder block, the reversal prevention pin having a lower end forming a slope structure, the slope structure being removably insertable into the positioning holes of the part strip located in the part transportation zone.
